(19) United States
(12) Patent Application Publication
(10) Pub. No.: US 2009/0004394 A1
(43) Pub. Date: Jan. 1, 2009

(54) Aqueous polymeric composition

(76) Inventors: Anne Denise Koller, Peymeinade (FR); Rosemarie Palmer Lauer, Chalfont, PA (US); Robert Mitchell Blankenship, Harleysville, PA (US); Wayne Devonport, Doylestown, PA (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 12/157,046

(22) Filed: Jun. 6, 2008

(30) Foreign Application Priority Data
Jun. 29, 2007 (EP) 07290825.4

(51) Int. Cl. B05D 3/00; C08K 5/09

(52) U.S. Cl. 427/385.5; 524/300

(57) ABSTRACT

An aqueous polymeric composition including an emulsion polymer including, as copolymerized units, from 0.5% to 25%, by weight based on the weight of the polymer, carbonyl-functional ethylenically-unsaturated monomer, and an autoxidizable material having less than 10%, by weight based on the weight of fatty acid residues therein, tri-unsaturated fatty acid residues; wherein the autoxidizable material is from 8% to 35% of the total weight of the polymer and the autoxidizable material; and wherein the polymeric composition is free from copolymerized-carbonyl-functional-monomer-reactive amine and hydrazine functional groups is provided. An aqueous coating composition including the aqueous polymeric composition, a method for improving the repaintability of an aqueous coating during drying, and a method for providing a coating are also provided.

This patent application claims the benefit of the earlier filed European Patent application serial number 07290825.4 filed on Jun. 29, 2007 under 37 CFR 1.55(a).

This invention relates to an aqueous polymeric composition. This invention particularly relates to an aqueous polymeric composition including an aqueous emulsion polymer and an autoxidizable material, an aqueous coating composition including the aqueous polymeric composition, a method for improving the repaintability of an aqueous coating during drying, and a method for providing a dry coating. More particularly, this invention relates to an aqueous polymeric composition including an emulsion polymer including, as copolymerized units, from 0.5% to 25%, by weight based on the weight of the polymer, carbonyl-functional ethylenically-unsaturated monomer, and an autoxidizable material having less than 10%, by weight based on the weight of fatty acid residues therein, tri-unsaturated fatty acid residues; wherein the autoxidizable material is from 8% to 35% of the total weight of the polymer and the autoxidizable material; and wherein the polymeric composition is free from copolymerized-carbonyl-functional-monomer-reactive amine and hydrazine functional groups.

The present invention serves to provide an aqueous polymeric composition that is particularly suitable for use in decorative and protective coatings for various substrates which coatings provide a sought-after balance of coatings properties, particularly including desirable application properties such as, for example, open time, flow, reflow, re-brushing, and repaint properties, and hardness development while maintaining desirable dry coatings properties, particularly including little or no yellowing.

U.S. Pat. No. 5,484,849 discloses an air curing polymer composition which contains acetoacetate functional polymer and an autoxidizable material. However, the problem faced by the inventors is the provision of an aqueous polymeric composition suitable for use in aqueous coatings which provide a high level of application properties and still yield dried coatings that maintain a desirable balance of coatings properties. Improvements in the application properties and dry coatings properties have been found to accrue with a select range of compositions wherein the autoxidizable material is from 8% to 35% of the total weight of the emulsion polymer and the autoxidizable material, further including only autoxidizable material having less than 10%, by weight based on the weight of fatty acid residues, tri-unsaturated fatty acid residues and ensuring that the aqueous polymeric composition and the aqueous coating composition is free from copolymerized-carbonyl-functional-monomer-reactive amine and hydrazine functional groups, elements associated with yellowing in polymeric coatings.

In a first aspect of the present invention there is provided an aqueous polymeric composition comprising an emulsion polymer comprising, as copolymerized units, from 0.5% to 25%, by weight based on the weight of said polymer, carbonyl-functional ethylenically-unsaturated monomer, and an autoxidizable material having less than 10%, by weight based on the weight of fatty acid residues therein, tri-unsaturated fatty acid residues; wherein said autoxidizable substance is from 8% to 35% of the total weight of said polymer and said autoxidizable material; and wherein said polymeric composition is free from copolymerized carbonyl-functional-monomer-reactive amine and hydrazine functional groups.

In a second aspect of the present invention there is provided an aqueous coating composition comprising a pigment and the aqueous polymeric composition of the first aspect of the present invention.

In a third aspect of the present invention there is provided a method for improving the repaintability of an aqueous coating during drying comprising (a) forming the aqueous coating composition of second aspect of the present invention; (b) applying said aqueous coating composition to a substrate; and (c) applying additional said aqueous coating composition to said applied aqueous coating composition during drying.

In a fourth aspect of the present invention there is provided a method for providing a coating comprising (a) forming the aqueous coating composition of the first aspect of the present invention; (b) applying said aqueous coating composition to a substrate; and (c) drying, or allowing to dry, said applied aqueous coating composition.

The aqueous polymeric composition of the invention includes an emulsion polymer including, as copolymerized units, from 0.5% to 25%, preferably from 5% to 20%, by weight based on the weight of the dry polymer, carbonyl-functional ethylenically-unsaturated monomer. Carbonyl-functional ethylenically-unsaturated monomers include, for example, (meth)acrolein, diacetone(meth)acrylamide, acetoacetoxyethyl(meth)acrylate, allyl acetoacetate, vinyl acetoacetate, vinyl acetoacetamide, acetoacetoxyethyl(meth)acrylamide, cyanoacetoxyethyl(meth)acrylate, cyanoacetoxypropyl(meth)acrylate, allyl cyanoacetate, and vinyl cyanoacetate and combinations thereof. Preferred carbonyl functional monomers include acetoacetoxyethyl(meth)acrylate, acetoacetoxypropyl(meth)acrylate, allyl acetoacetate, acetoacetoxybutyl(meth)acrylate, 2,3-di(acetoacetoxy)propyl (meth)acrylate, and combinations thereof. More preferred is acetoacetoxyethyl methacrylate

The emulsion polymer typically includes at least one copolymerized nonionic ethylenically unsaturated monomer not bearing carbonyl functionality such as, for example, a (meth)acrylic ester monomer including methyl(meth)acrylate, ethyl(meth)acrylate, butyl (meth)acrylate, 2-ethylhexyl(meth)acrylate, decyl(meth)acrylate, hydroxyethyl(meth)acrylate, hydroxypropyl(meth)acrylate, and ureido-functional(meth)acrylates; styrene or substituted styrenes; vinyl toluene; butadiene; monoethylenically unsaturated acetophenone or benzophenone derivatives such as, for example are taught in U.S. Pat. No. 5,162,415; vinyl acetate or other vinyl esters; vinyl monomers such as vinyl chloride, vinylidene chloride, and N-vinyl pyrollidone. By “nonionic monomer” herein is meant that the copolymerized monomer residue does not bear an ionic charge between pH=1-14. The use of the term “(meth)” followed by another term such as (meth)acrylate, as used throughout the disclosure, refers to both acrylates and methacrylates. Preferred is an acrylic emulsion polymer by which is meant herein an emulsion polymer including, as copolymerized units, at least 40%, by weight based on polymer weight, of nonionic acrylic monomers such as for example esters derived from (meth)acrylic acid.

In certain embodiments the emulsion polymer includes from 0% to 6%, or in the alternative, from 0% to 3 wt % or from 0% to 1%, by weight based on the weight of the polymer, of a copolymerized multi-ethylenically unsaturated monomer. It is important to select the level of multi-ethylenically unsaturated monomer so as to not materially interfere with film formation and integrity. In certain embodiments the emulsion polymer is free from copolymerized multi-ethylenically unsaturated monomer. Multi-ethylenically unsaturated monomers include, for example, allyl(meth)acrylate, diallyl phthalate, 1,4-butylene glycol di(meth)acrylate, 1,2-ethylene glycol di(meth)acrylate, 1,6-hexanediol di(meth)acrylate, and divinyl benzene.

The emulsion polymer includes from 0% to 15%, preferably from 1% to 7%, of a copolymerized monoethylenically-unsaturated acid monomer, based on the weight of the polymer. Acid monomers include carboxylic acid monomers such as, for example, (meth)acrylic acid, crotonic acid, itaconic acid, fumaric acid, maleic acid, monomethyl itaconate, monomethyl fumarate, monobutyl fumarate, maleic anhydride, 2-acrylamido-2-methylpropane sulfonic acid, vinyl sulfonic acid, styrene sulfonic acid, 1-allyloxy-2-hydroxypropane sulfonic acid, alkyl allyl sulfosuccinic acid, sulfoethyl(meth)acrylate, phosphoalkyl(meth)acrylates such as phosphoethyl(meth)acrylate, phosphopropyl(meth)acrylate, and phosphobutyl(meth)acrylate, phosphoalkyl crotonates, phosphoalkyl maleates, phosphoalkyl fumarates, phosphodialkyl(meth)acrylates, phosphodialkyl crotonates, and allyl phosphate. Acid monomers used to form the acrylic polymer may include acid functional macromonomers and polymerizable acid functional anionic surfactants. In certain embodiments the emulsion polymer may include from 0 to 2%; preferably from 0.5% to 2% by weight, based on the weight of the polymer, of a copolymerized amide-functional ethylenically unsaturated monomer, such as, for example, (meth)acrylamide. In certain embodiments the emulsion polymer may include from 0% to 15%; preferably from 0.5% to 7% by weight, based on the weight of the polymer, of a copolymerized hydroxy functional monomer such as, for example, hydroxyethyl(meth)acrylate and hydroxypropyl(meth)acrylate. Combinations of any, or all, of the group including acid, amide, and hydroxy functional monomers are contemplated. Typically the monomers used to form the emulsion polymer will include a total of from 0.5 to 15%; preferably 0.5 to 7% by weight, based on the weight of the emulsion polymer, monomers selected from the group of acid, amide, and hydroxy functional monomers, the level of amide functional monomer being limited to 2%.

The calculated glass transition temperature (“Tg”) of the emulsion polymer is from −20° C. to 105° C., preferably from −10° C. to 60° C. Tgs of the polymers are calculated herein by using the Fox equation (T. G. Fox, Bull. Am. Physics Soc., Volume 1, Issue No. 3, page 123(1956)). that is, for calculating the Tg of a copolymer of monomers M1 and M2,

1/Tg(calc.)=w(M1)/Tg(M1)+w(M2)/Tg(M2), wherein
Tg(calc.) is the glass transition temperature calculated for the copolymer
w(M1) is the weight fraction of monomer M1 in the copolymer
w(M2) is the weight fraction of monomer M2 in the copolymer
Tg(M1) is the glass transition temperature of the homopolymer of M1
Tg(M2) is the glass transition temperature of the homopolymer of M2, all temperatures being in °K.

The glass transition temperature of homopolymers may be found, for example, in “Polymer Handbook”, edited by J. Brandrup and E. H. Immergut, Interscience Publishers.

The aqueous emulsion polymer is formed by an addition polymerization emulsion polymerization process as is known in the art. Conventional surfactants may be used such as, for example, anionic and/or nonionic emulsifiers such as, for example, alkali metal or ammonium alkyl sulfates, alkyl sulfonic acids, fatty acids, and oxyethylated alkyl phenols. Polymerizable surfactants that include at least one ethylenically unsaturated carbon-carbon bond which can undergo free radical addition polymerization may be used. Examples of anionic polymerizable surfactants include MAXEMUL™ 6106, MAXEMUL™ 6112, MAXEMUL™ 5011, MAXEMUL™ 5010 (all available from Uniquema); polyoxyethylene alkylphenyl ether ammonium sulfates (available from Montello, Inc. as HITENOL BC-10™, HITENOL BC-1025™, HITENOL BC-20™, HITENOL BC-2020™, HITENOL BC-30™), and allylsulfosuccinate derivatives (such as TREM LT-40™ (available from Henkel)). The amount of surfactant used is usually 0.1% to 6% by weight, based on the weight of total monomer. Either thermal or redox initiation processes may be used. Conventional free radical initiators may be used such as, for example, hydrogen peroxide, t-butyl hydroperoxide, t-amyl hydroperoxide, ammonium and/or alkali persulfates, typically at a level of 0.01% to 3.0% by weight, based on the weight of total monomer. Redox systems using the same initiators coupled with a suitable reductant such as, for example, sodium sulfoxylate formaldehyde, sodium hydrosulfite, isoascorbic acid, hydroxylamine sulfate and sodium bisulfite may be used at similar levels, optionally in combination with metal ions such as, for example iron and copper, optionally further including complexing agents for the metal. Chain transfer agents such as mercaptans may be used to lower the molecular weight of the polymer. The monomer mixture may be added neat or as an emulsion in water. The monomer mixture may be added in a single addition or more additions or continuously over the reaction period using a uniform or varying composition. Additional ingredients such as, for example, free radical initiators, oxidants, reducing agents, chain transfer agents, neutralizers, surfactants, and dispersants may be added prior to, during, or subsequent to the monomer addition. Processes yielding polymodal particle size distributions such as those disclosed in U.S. Pat. Nos. 4,384,056 and 4,539,361, for example, may be employed.

The emulsion polymer may be formed in a multi-stage emulsion polymerization process. In the multi-stage emulsion polymerization process at least two stages different in composition are formed in sequential fashion. Preferred is a two-stage emulsion polymerization process in which the weight of the first stage polymer is from 10% to 90%, preferably from 30% to 70%, of the total weight of the first stage polymer and the second stage polymer, based on dry polymer weights. The polymerization techniques used to prepare aqueous multi-stage emulsion-polymers are well known in the art such as, for example, as disclosed in U.S. Pat. Nos. 4,325,856; 4,654,397; and 4,814,373.

A multi-stage emulsion polymerization process usually results in the formation of at least two mutually incompatible polymer compositions, thereby resulting in the formation of at least two phases. The mutual incompatibility of two polymer compositions and the resultant multiphase structure of the polymer particles may be determined in various ways known in the art. The use of scanning electron microscopy using staining techniques to emphasize the difference between the phases, for example, is such a technique. Such particles are composed of two or more phases of various geometries such as, for example, core/shell or core/sheath particles, core/shell particles with shell phases incompletely encapsulating the core, core/shell particles with a multiplicity of cores, and interpenetrating network particles. Each of the stages of the multi-staged emulsion polymer may contain the same monomers, surfactants, initiation system, chain transfer agents, etc. as disclosed herein-above for the emulsion polymer. In the case of a multi-staged polymer particle the physical characteristics of the emulsion polymer such as for example, carbonyl-functional monomer content, acid monomer content, Tg, etc. for the purpose of this invention is to be calculated using the overall composition of the emulsion polymer without regard for the number of stages or phases therein. The emulsion polymer is also contemplated to be formed in two or more stages, the stages differing in molecular weight. Blending two different emulsion polymers is also contemplated.

The average particle diameter of the emulsion polymer particles is typically from 40 nanometers to 1000 nanometers, preferably from 40 nanometers to 300 nanometers. Particle sizes herein were those measured by dynamic light scattering on a Brookhaven BI-90 analyzer. Latex samples were diluted to the appropriate concentration with 1N KCl (aq.)

The aqueous polymeric composition of the present invention includes an autoxidizable material. An autoxidizable material is a material capable of providing a source of free radicals upon exposure to oxygen. “Autoxidizable material” herein includes drying oils such as linseed oil, tung oil, dehydrated castor oil; drying oil fatty acids, such as linseed oil fatty acid; alkyds derived from drying oils; acrylate modified alkyd resins; esters of drying oil fatty acids such as the ethyl ester of linseed oil fatty acid sorbitol, and sorbitol esters, glycerol and glycerol esters, or esters of trimethylol propane; and alkoxylated derivatives thereof. The autoxidizable material herein excludes hybrids of drying oils, such as oils, fatty acid residues, oil derivatives, and the like combined chemically with or incorporated in condensation polymers other than polyesters and alkyds such as, for example, polyurethanes and polyamides.

The autoxidizable material includes fatty acid residues, i.e., a fatty acid residue herein being a RC(C═O)O— grouping where R is a C8 to C28 hydrocarbon backbone containing at least one unsaturated bond. The autoxidizable material of this invention includes less than 10 weight %, alternatively less than 8 weight %, and alternatively less than 5 weight %, triunsaturated fatty acid residues based on the total weight of the fatty acid residues included in the autoxidizable material in the aqueous polymeric composition. The use of higher levels of the triunsaturated autoxidizable material is believed to lead to the development of yellow color in the dry coating films prepared from the aqueous polymeric composition of the present invention.

Without being bound by a particular theory, it is believed that upon exposure to air the autoxidizable material will generate a radical flux that will lead to self-cross linking and cross linking with the carbonyl-functional emulsion polymer. In order to facilitate the autoxidation process a drier or mixture thereof is included in the film-forming composition. This component may be any polyvalent metal containing complex or salt that cataylzes the oxidative curing of autoxidizable material. Examples are polyvalent metal salts containing cobalt, calcium, manganese, copper, zinc, iron, and zirconium as the cation. Simple salts such as the halides, nitrates, and sulfates may be used but in many cases an organic anion such as the acetate, naphthenate, or the acetoacetonate may be used for solubility or compatibility reasons. A commercial example of an appropriate drier is Additol™ VXW4940, manufactured by Cytec.

The amount of drier used is typically in the range of 0.01 to 1% metal content based on the weight of the aqueous polymeric composition. The autoxidation process will take place without drier but it is significantly slower at room temperature.

In the aqueous polymeric composition the autoxidizable substance is from 8% to 35%, preferably from 10% to 25%, more preferably from 10% to 20%, of the total weight of the polymer and the autoxidizable material, both the polymer weight and the autoxidizable material weight being on a dry basis.

The aqueous polymeric composition and the aqueous coating composition of the invention are both free from copolymerized carbonyl-functional-monomer-reactive amine and hydrazine functional groups. It is believed that decreased yellowing of the coating is thereby achieved.

The aqueous coating composition is prepared by techniques which are well known in the coatings art. First, pigment(s) are well dispersed in an aqueous medium under high shear such as is afforded by a COWLES (R) mixer or predispersed colorant(s), or mixtures thereof are used. Then the aqueous polymeric composition is added under low shear stirring along with other coatings adjuvants as desired. The autoxidizable material may be combined with the aqueous emulsion polymer in the presence or absence of solvent or in an aqueous dispersion. Alternatively, the aqueous emulsion polymer and the autoxidizable material are added separately. The aqueous coating composition may contain, in addition to the emulsion polymer and pigment(s), film-forming or non-film-forming solution or emulsion polymers in an amount of 0% to 200% by weight of the emulsion polymer, and conventional coatings adjuvants such as, for example, extenders, emulsifiers, coalescing agents, plasticizers, antifreezes, curing agents, buffers, neutralizers, thickeners, rheology modifiers, humectants, wetting agents, biocides, plasticizers, antifoaming agents, UW absorbers, fluorescent brighteners, light or heat stabilizers, biocides, chelating agents, dispersants, colorants, waxes, and water-repellants. In certain embodiments a photosensitive compound such as, for example, benzophenone or a substituted acetophenone or benzophenone derivative as is taught in U.S. Pat. No. 5,162,415 may be added. In certain embodiments the aqueous coating composition of the invention has a VOC (volatile organic compound) level of 150 g/liter of coating or less, alternatively of 100 g/liter or less, or further alternatively of 50 g/liter or less.

Examples of suitable pigments and extenders include titanium dioxide such as anatase and rutile titanium dioxides; zinc oxide; antimony oxide; iron oxide; magnesium silicate; calcium carbonate; organic and inorganic colored pigments; aluminosilcates; silica; various clays such as kaolin and delaminated clay; and lead oxide. It is also contemplated that the aqueous coating composition may also contain opaque polymer particles, such as, for example, Ropaque™ Opaque Polymers (Rohm and Haas Co., Philadelphia Pa.).

The amounts of pigment and extender in the aqueous coating composition vary from a pigment volume concentration (PVC) of 0 to 85 and thereby encompass coatings otherwise described in the art, for example, as clear coatings, stains, flat coatings, satin coatings, semi-gloss coatings, gloss coatings, primers, textured coatings, and the like. The pigment volume concentration is calculated by the following formula:

$$PVC ( \% ) = \frac{\begin{matrix}volume of pigment ( s ) , + \\ volume extender ( s ) \times 100\end{matrix}}{total dry volume of paint}$$

Frequently a VOC is deliberately added to a paint or coating to improve the film properties of a coating or to aid in the application properties of the composition employed to prepare the coating. Examples are glycol ethers, organic esters, aromatic compounds, ethylene and propylene glycol, and aliphatic hydrocarbons. The inventive dispersions are particularly useful in the formation of aqueous coating compositions having less than 5% VOC, or less than 3% VOC, or less than 1.7% VOC, by weight based on the total weight of the aqueous coating composition. A volatile organic compound (“VOC”) is defined herein as a carbon containing compound that has a boiling point below 250° C. at atmospheric pressure, compounds such as water and ammonia being excluded from VOCs.

The solids content of the aqueous coating composition may be from 10% to 70% by volume. The viscosity of the aqueous coating composition may be from 50 centipoise to 50,000 centipoise, as measured using a Brookfield viscometer; viscosities appropriate for different application methods vary considerably.

The aqueous coating composition is typically applied to a substrate such as, for example, wood, metal, plastics, cementitious substrates such as, for example, concrete, stucco, and mortar, previously painted or primed surfaces, and weathered surfaces. The aqueous coating composition may be applied to a substrate using conventional coatings application methods such as, for example, curtain coater and spraying methods such as, for example, air-atomized spray, air-assisted spray, airless spray, high volume low pressure spray, and air-assisted airless spray.

A method for improving the repaintability of an aqueous coating during drying is also provided including forming the aqueous coating composition; applying the aqueous coating composition to a substrate; and then applying more of the aqueous coating composition to the previously applied aqueous coating composition during drying. Improving the repaintability of an aqueous coating during drying refers herein to the ability, relative to prior aqueous coatings, to blend in newly applied aqueous coating into previously applied but not completely dry aqueous coating for as long a period of time as possible resulting in a seamless or nearly seamless appearance in the resulting dry coating. This relates to overlapping areas of wet coating during the drying process. This ability, reflected in reflow/repaint test results, for example, is a highly desirable coating application property.

Drying of the aqueous coating composition to provide a coating may be allowed to proceed under ambient conditions such as, for example, at 5° C. to 35° C. or the coating may be dried at elevated temperatures such as, for example, from 35° C. to 150° C.

### Abbreviations Used Homopolymer Tg

Acetoacetoxyethyl methacrylate AAEM
Butyl acrylate BA
Ethylhexyl acrylate EHA
Methyl methacrylate MMA
Butyl Methacrylate BMA
Methacrylic acid MAA
tButyl hydroperoxide (70%) tBHP
Isoascorbic acid IAA
Ammonium persulfate APS
n-Dodecanethiol nDDM
deionized water DI water

### Experimental Methods

### Reflow/Renaint Test—X Test

Secured Leneta Chart (Form 12H, 1000 cm2) to vertical surface. Using 1 ½-2″ in wide paint brush, painted out design area of chart and recorded weight of paint. Immediately, using the tip of a wooden applicator stick or pipette, scored an X in each of the 4 quadrants of the chart (about 3×3″ in size). Start timer. At the designated time intervals, each of the X scored areas were repainted. The paint brush, prior to the repaint process, was redipped in the paint to wet the brush but no or only a slight amount of new paint was applied to the repaint area. The test chart remained hung overnight to dry. The next day, the chart was. visually evaluated for initial flow and leveling (single coat areas).

Flow/Leveling: 1=very poor, 10=excellent (very smooth) Then the flow and leveling was rated visually in each of the four repainted areas. Each quadrant is examined for the persistence of the scored X mark and the longest time interval at which no vestige of the X is apparent is recorded.

### Large Substrate Reflow Test

### Or 4 Chart Application Test Method

This method gives a rating for flow and leveling and open time
1) Taped 4 Leneta spread rate charts together with a total surface area=0.4 m²
2) Taped chart assembly to a wall
3) Brushed out all four charts by covering first the two left charts and finishing with the two right charts. Noted ease of spreading, brush drag
4) Finished up by feathering horizontally then vertically with the brush
5) Started the time watch
6) After 4 minutes, re-brushed vertically the two right charts without re-dipping the brush into the paint. Again, noted any brush feeling
7) Let the paint dry overnight
8) Rated the flow and leveling from 1 to 10 (10=best) on each side of the chart assembly. The open time is the best when the re-brushed area flowed as well as the original area.

### Konig Hardness:

Aqueous coating was drawn down at the designated film thickness using appropriate applicator over aluminum or glass panel and allowed to dry under constant temperature and humidity conditions (25° C., 50% RH). At 1, 7 14 days, the hardness was measured using a Byk Mallinckrodt Konig Pendulum Hardness Tester.

### Gloss, Glass:

A drawdown of the test sample was prepared on an appropriately sized glass panel using a 4-5 mil Bird film applicator. The panel was allowed to dry in the CTR overnight. The 20° or 60° specular gloss was measured using a micro-TRI-gloss meter from BYK Gardner. Gloss was remeasured after 7 days of drying.

### Gloss, Chart:

An aqueous coating composition was drawn down on 5C Leneta Chart using a 4-5 mil Bird applicator. The coating was allowed to dry overnight. The 20° or 60° specular gloss was measured using a micro-TRI-gloss meter from BYK Gardner. Gloss was remeasured after 7 days of drying.

### Hot Peel Block Resistance:

1. Cast the paint to be tested on the chart using a 3 Mil Bird applicator. Conditioned panels in the CTR (25° C.; 50% RH) for 7 days.
2. Cut out four 1½″×1½″ sections (to run duplicates) from white area of each conditioned panel.
3. Placed the cut sections with the paint surfaces face to face.
4. Placed two face to face specimens of each test sample in a 50° C. (120° F.) oven on a flat metal plate. Topped each individual specimen with a heated, solid, number 8 rubber stopper with narrow side down and place a heated 1000 g. weight on each stopper. The force calculated for this setup is 127 g/cm2 (1.8 psi).
5. After approximately 18 hours, removed the stoppers and weights and removed the test sections from the oven. Allowed the test specimens to cool 30 minutes at room temperature.
6. After cooling, separated the sections with slow and steady force. Pulled apart at an angle of approximately 180° and listened for tack. Rated the samples for block resistance on a scale of 0 to 10.

### Room Temperature Block Resistance:

Repeated exactly as Hot Peel Block Resistance but ran test at 25° C./50% RH.

### Block Reporting:

1. Block resistance was reported on a numerical scale of 0 to 10, which corresponds to a subjective tack and seal rating determined by the operator. This rating system is defined below in appropriate descriptive terms. All variations of the Peel Block Resistance Test rate samples on the following scale:

10, no tack, perfect

9, trace tack, excellent

8, slight tack, very good

7, slight tack, good

6, moderate tack, good

5, moderate tack, fair

4, severe tack, no seal, fair

3, 5-25% seal, poor

2, 25-50% seal, poor

1, 50-75% seal, poor

0, complete seal, very poor

Block Resistance Test 2

Results are reported in N/cm2.

1) Using an automatic applicator, cast paint on spreading rate charts using a 100 micron bar.

2) Dried applications for 1 and 7 days at 23° C.+/2, 50% R.H. ±5.

3) Using a two face adhesive tape, taped microscope slides on the back of the chart. Cut the glass slides with a cutter, six slides per paint (3 replicates).

4) Placed the paint surface face-to-face and the length of the slides at right angles to each other so that they formed a cross.

5) Placed glass assemblies in a press and applied two kg for two hours.

6) After two hours, placed a glass assembly in the dedicated slot of the Byk/Rohm and Haas block tester.

7) Chose a weight and placed it at the right end side of the tester lever.

8) Lowered the lever slowly on top of the glass assembly.

9) Ran the automated weight movement from right to left until the glass plates separated.

10) Noted the rating on the ruler.

11)Reported force in N/Cm² using a table (force v.s. weight, rating).

The lower the force the better the block resistance.

| Rating | Weight (g) | Force (N/Cm²) |
|---|---|---|
| 0 | | 0 |
| 100 | 1000 | 0.33 |
| 700 | 1500 | 2.14 |
| 1100 | 3500 | 5.42 |
| 1100 | 5000 | 7.02 |
| 1600 | 5000 | 9.97 |

### Synthesis of Emulsion Polymer a

Monomer Emulsion 1—Surfactant A (10.4 g) was dissolved in DI water (250.6 g). An emulsified monomer mixture was prepared by adding the following monomers slowly to the agitated solution; BA (81 g), BMA (340.8 g), Styrene (283.4 g), MAA (40.4 g), AAEM (64.8 g), n-DDM (16.2 g). Monomer Emulsion 2—Surfactant A (10.4 g) was dissolved in DI water (250.6 g). Emulsified monomer mixture was prepared by adding the following monomers slowly to the agitated solution; BA (81.0 g), BMA (340.8 g), Styrene (283.4 g), MAA (40.4 g), AAEM (64.8 g), n-DDM (2.1 g).

A solution containing Surfactant B (60.3 g) and DI water (1080 g) was placed in a 4-necked, 5 liter round bottom flask reactor equipped with a thermocouple, a cooling condenser and an agitator, and heated to 85° C. under nitrogen. Sodium carbonate (5.4 g in 91.8 g of water), APS (4.4 g in 32.4 g of water), and 10% of Monomer Emulsion 1 were added to the reactor. Within about 5 minutes, initiation of polymerization was confirmed by the increase of temperature by 3° C. and change of the external appearance of the reaction mixture. After generation of heat had ended, the remainder of the Monomer Emulsion 1 and a co-feed of APS (0.9 g in 108 g of water) were added to the reactor over a period of 45 minutes. Polymerization reaction temperature was maintained at 84-87° C. After completing the addition, the vessel that contained Monomer Emulsion 1 and the feeding pipes leading into the reactor were rinsed with 50 g DI water, and the rinse was added back to the reactor. Upon completion of the rinse, Monomer Emulsion 2 was then added over 45 minutes. Polymerization reaction temperature was maintained at 84-86° C. After completing the addition, the vessel that contained the Monomer Emulsion 2 and the feeding pipes were rinsed with 250 g DI water, and the rinse was added back to the reactor. Upon completion of the additions the reaction mixture was cooled to 60° C. before addition of iron sulfate (10.8 g of a 0.015% solution in water). t-BHP(70%, 1.1 g in 13 g water) was added to the reactor followed by the gradual addition of IAA (0.54 g in 18.4 g water) over 30 minutes. Upon completion of the feeds, the reaction was cooled to room temperature and ammonia (29%, 37.8 g) added to adjust the pH. The resulting polymer emulsion was characterized to contain 44.6% solids, pH=8.5, 98 nm particle size.

### Synthesis of Emulsion Polymer b

Emulsion polymer b has the same composition as emulsion polymer a and was prepared according to the same process. The resulting polymer emulsion was characterized to contain 47.1% solids, pH=8, 106 nm particle size.

### Synthesis of Emulsion Polymer c

Monomer Emulsion—Surfactant A (28.4 g) was dissolved in DI water (230 g). An emulsified monomer mixture was prepared by adding the following monomers slowly to the agitated solution; BA (323 g), MMA (450.5 g), MAA (12.8 g), AAEM (63.8 g.

A solution containing Surfactant A (2.8 g) and DI water (821 g) was placed in a reactor equipped with a thermocouple, a cooling condenser and an agitator, and heated to 80 C under nitrogen. APS (3.8 g in 35 g of water), and 3.80% of Monomer Emulsion were added to the reactor. Within 5 minutes, initiation of polymerization was confirmed by the increase of temperature by 3° C. and change of the external appearance of the reaction mixture. After generation of heat had ended, the remainder of the Monomer Emulsion was added to the reactor over a period of 90 minutes. Simultaneously a co-feed of APS (0.5 g in 50 g of water) was added to the reactor over a period of 135 minutes. Polymerization reaction temperature was maintained at 80-82° C. After completing the addition, the vessel that contained the Monomer Emulsion and the feeding pipes were rinsed with 40 g DI water, and the rinse was added back to the reactor. Upon completion of the additions, the reaction mixture was held at 80° C. for 60 minutes before cooling to 70° C. Iron sulfate (log of a 0.015% solution in water) and Copper sulfate (1.2 g of a 0.1% solution in water) were added to the reactor. t-BHP (70%, 0.7 g in 3.5 g water) and IAA (0.5 g in 25 g water) were added to the reactor and the mixture held at 70 C for 30 minutes. After the hold period a solution of t-BHP (70%, 1.8 g in 30 g water) was added to the reactor, followed by the gradual addition of a second solution of IAA (1.3 g in 30 g water) over 30 minutes. Upon completion of the feeds, the reaction was cooled to room temperature and ammonia (29%, 14.5 g) added to adjust the pH. The resulting polymer emulsion was characterized to contain 40% solids, pH=8, 103 nm particle size.

### Synthesis of Emulsion Polymer d

Monomer Emulsion—Surfactant A (67.5 g) was dissolved in DI water (619 g). An emulsified monomer mixture was prepared by adding the following monomers slowly to the agitated solution; BA (845.3 g), styrene (1131.1 g), MAA (30.4 g), ureido methacrylate (40.5 g), n-DDM (2 g).

A solution containing Surfactant A (4.5 g) and DI water (1421.6 g) was placed in a reactor equipped with a thermocouple, a cooling condenser and an agitator, and heated to 85° C. under nitrogen. APS (5.0 g in 27 g of water), and 3.0% of Monomer Emulsion were added to the reactor. Within about 5 minutes, initiation of polymerization was confirmed by the increase of temperature by 3° C. and change of the external appearance of the reaction mixture. After generation of heat had ended, the remainder of the Monomer Emulsion and a co-feed of APS (3.0 g in 100 g of water) were added to the reactor over a period of 175 minutes. Polymerization reaction temperature was maintained at 84-86° C. After completing the addition, the vessel that contained the Monomer Emulsion and the feeding pipes were rinsed with 50 g DI water, and the rinse was added back to the reactor.

Upon completion of the additions the reaction mixture was cooled to 80 C before addition of iron sulfate (log of a 0.015% solution in water). t-BHP (70%, 5.6 g in 25 g water) was added to the reactor followed by the gradual addition of IAA (4 g in 100 g water) over 30 minutes. The reaction mixture was held at 80° C. for 15 minutes before cooling to 60° C. After the hold period a solution of t-BHP (70%, 2.8 g in 15 g water) was added to the reactor, followed by the gradual addition of a second solution of IAA (2.0 g in 50 g water) over 30 minutes. Upon completion of the feeds, the reaction was cooled to room temperature and ammonia (29%, 14.5 g) added to adjust the pH. The resulting polymer emulsion was characterized to contain 44.3% solids, pH=8.3, 151 nm particle size.

### Synthesis of Emulsion Polymer e

Monomer Emulsion 1—Surfactant A (52 g) was dissolved in DI water (1250 g). Emulsified monomer mixture was prepared by adding the following monomers slowly to the agitated solution; BA (405 g), BMA (1704 g), Styrene (1417 g), MAA (202 g), AAEM (324 g), n-DDM (81 g).
Monomer Emulsion 2—Surfactant A (52 g) was dissolved in DI water (1250 g). An emulsified monomer mixture was prepared by adding the following monomers slowly to the agitated solution; BA (405 g), BMA (1704 g), Styrene (1417 g), MAA (202 g), AAEM (324 g), n-DDM (10.3 g).

A solution containing Surfactant B (301.5 g) and DI water (5400 g) was placed in a 4-necked, 5 liter round bottom flask reactor equipped with a thermocouple, a cooling condenser and an agitator, and heated to 85° C. under nitrogen. Sodium carbonate (27 g in 459 g of water), APS (22 g in 162 g of water), and 10% of Monomer Emulsion 1 were added to the reactor. Within about 5 minutes, initiation of polymerization was confirmed by the increase of temperature by 3° C. and change of the external appearance of the reaction mixture. After generation of heat had ended, the remainder of the Monomer Emulsion 1 and a co-feed of APS (4.3 g in 540 g of water) were added to the reactor over a period of 45 minutes. Polymerization reaction temperature was maintained at 84-87° C. After completing the addition, the vessel that contained Monomer Emulsion 1 and the feeding pipes leading into the reactor were rinsed with 50 g DI water, and the rinse was added back to the reactor. Upon completion of the rinse, Monomer Emulsion 2 was then added over 45 minutes. Polymerization reaction temperature was maintained at 84-86° C. After completing the addition, the vessel that contained the Monomer Emulsion 2 and the feeding pipes were rinsed with 250 g DI water, and the rinse was added back to the reactor. Upon completion of the additions the reaction mixture was cooled to 60 C before addition of iron sulfate (54 g of a 0.015% solution in water). t-BHP (70%, 5.4 g in 65 g water) was added to the reactor followed by the gradual addition of IAA (2.7 g in 92 g water) over 30 minutes. Upon completion of the feeds, the reaction was cooled to room temperature and ammonia (29%, 189 g) added to adjust the pH. The resulting polymer emulsion was characterized to contain 44.8% solids, pH=8.5, 98 nm particle size.

### Synthesis of Emulsion Polymer f

Monomer Emulsion—Surfactant A (73.2 g) was dissolved in DI water (388 g). Emulsified monomer mixture was prepared by adding the following monomers slowly to the agitated solution; EHA (397.7 g), MMA (674.9 g), MAA (42.2 g), AAEM (90 g), n-DDM (2.4 g).

A solution containing Surfactant A (0.4 g) and DI water (803.4 g) was placed in an appropriate reactor equipped with a thermocouple, a cooling condenser and an agitator, and heated to 85° C. under nitrogen. APS (3.2 g in 32 g of water), and 3.2% of Monomer Emulsion were added to the reactor. Within about 5 minutes, initiation of polymerization was confirmed by the increase of temperature by 3° C. and change of the external appearance of the reaction mixture. After generation of heat had ended, the remainder of the Monomer Emulsion and a co-feed of APS (3.2 g in 80 g of water) were added to the reactor over a period of 90 minutes. Polymerization reaction temperature was maintained at 84-86° C. After completing the addition, the vessel that contained the Monomer Emulsion and the feeding pipes were rinsed with 25 g DI water, and the rinse was added back to the reactor.

Upon completion of the additions the reaction mixture was cooled to 70° C. before addition of iron sulfate (9.1 g of a 0.015% solution in water), Versene™ (1.1 g of a 1% solution in water). t-BHP (70%, 1.1 g in 32 g water) and IAA (0.8 g in 32 g water) were added to the reactor over 30 minutes. Upon completion of the feeds, the reaction was cooled to room temperature and ammonia (29%, 60.7 g) added to adjust the pH, followed by addition of Proxel™ (6.8 g of an 18% solution in water) was added. The resulting polymer emulsion was characterized to contain 43.2% solids, pH=9.1, 125 nm particle size.

### Synthesis of Emulsion Polymer g

Monomer Emulsion—Surfactant A (90.7 g) was dissolved in DI water (481.6 g). An emulsified monomer mixture was prepared by adding the following monomers slowly to the agitated solution; EHA (493.1 g), MMA (724.8 g), MAA (52.3 g), AAEM (224.2 g), n-DDM (14.9 g).

A solution containing Surfactant A (0.5 g) and DI water (996.2 g) was placed in an appropriate reactor equipped with a thermocouple, a cooling condenser and an agitator, and heated to 85 C under nitrogen. APS (4 g in 39.8 g of water), and 3.2% of Monomer Emulsion were added to the reactor. Within about 5 minutes, initiation of polymerization was confirmed by the increase of temperature by 3° C. and change of the external appearance of the reaction mixture. After generation of heat had ended, the remainder of the Monomer Emulsion and a co-feed of APS (4.0 g in 10 g of water) were added to the reactor over a period of 90 minutes. Polymerization reaction temperature was maintained at 84-86° C. After completing the addition, the vessel that contained the Monomer Emulsion and the feeding pipes were rinsed with 31 g DI water, and the rinse was added back to the reactor.

Upon completion of the additions the reaction mixture was cooled to 70° C. before addition of iron sulfate (11.3 g of a 0.015% solution in water), Versene™ (1.41 g of a 1% solution in water). t-BHP (70%, 1.4 g in 39.8 g water) and IAA (1.0 g in 39.8 g water) were added to the reactor over 30 minutes. Upon completion of the feeds, the reaction was cooled to room temperature and ammonia (29%, 75.3 g) added to adjust the pH, followed by addition of Proxel™ (8.4 g of an 18% solution in water) was added. The resulting polymer emulsion was characterized to contain 43.4% solids, pH=8.4, 127 nm particle size.

### Synthesis of Emulsion Polymer h

Emulsion polymer h has the same composition as emulsion polymer a and was prepared according to the same process.

As used herein Surfactant A is a fatty alcohol polyglycol ether sulfate with an average of level of ethoxylation equal to three EO units; Surfactant B is a polyoxyethylene tridecyl ether phosphate with an average level of ethoxyation equal to six EO units.

### EXAMPLES 1-4

Preparation of aqueous coating compositions and evaluation of the compositions and coatings prepared therefrom. Compositions that contained alkyd emulsions were prepared as presented in Table 1.1. The evaluation of the compositions and coatings prepared therefrom are presented in Table 1.2. Table 1.1

TABLE 1.1

| | Example | | | | |
|---|---|---|---|---|---|
| | Comp. Ex. A | 1 | 2 | 3 | 4 |
| Emulsion polymer | c | c | c | c | c |
| Autoxidizable | 0 | 15% | 25% | 15% | 25% |
| material | | WorleeSol ™ | WorleeSol ™ | Chempol ™ | Chempol ™ |
| | | E150W | E150W | 1364 | 1364 |
| Grind: | | | | | |
| Water | 11.71 | 11.86 | 11.46 | 11.84 | 11.45 |
| Tamol ™ 731A | 2.25 | 2.28 | 2.28 | 2.27 | 2.26 |
| BYK-019 | 0.57 | 0.57 | 0.57 | 0.57 | 0.57 |
| Surfynol ™ CT- | 0.28 | 0.28 | 0.28 | 0.28 | 0.28 |
| 111 | | | | | |
| Acrysol ™ RM- | 0.72 | 0.73 | 0.73 | 0.73 | 0.72 |
| 5000 | | | | | |
| Ammonia (29%) | 0.09 | 0.09 | 0.09 | 0.09 | 0.09 |
| Ti-Pure ™ R-706 | 56.20 | 56.95 | 56.95 | 56.83 | 56.46 |
| Additol ™ VXW | 1.03 | 1.04 | 1.45 | 1.04 | 1.45 |
| 4940 | | | | | |
| Grind Sub-total | 72.85 | 73.80 | 73.81 | 73.65 | 73.28 |
| LetDown | | | | | |
| Emulsion polymer | 182.61 | 153.86 | 135.75 | 154.08 | 136.22 |
| Worlee Sol ™ | | 27.15 | 45.25 | | |
| E150W | | | | | |
| Chempol ™ 821- | | | | 27.67 | 46.22 |
| 1364 | | | | | |
| Ammonia (28%) | 0.55 | 0.31 | 0.70 | 0.50 | 0.70 |
| Texanol ™ | 8.76 | 6.52 | 6.88 | 6.50 | 5.09 |
| Acrysol ™ RM- | 3.00 | 3.00 | 3.00 | 3.08 | 3.00 |
| 5000 | | | | | |
| BYK ™-024 | 1.04 | 1.03 | 1.03 | 1.03 | 1.04 |
| Add Grind | 72.85 | 73.80 | 73.81 | 73.65 | 73.28 |
| pH | 8.3/8.9 | 8.1/8.8 | 8.3/9.0 | 8.3/8.8 | 8.24 |
| Ammonia (28%) | 0.59 | 0.49 | 0.52 | 0.43 | 0.94 |
| Water | 3.12 | 6.24 | 4.42 | 3.99 | 4.05 |
| Acrysol ™ RM5000 | 2.48 | 2.6 | 3.64 | 4.07 | 4.88 |
| Acrysol ™ RM-8W | 0.00 | | 0.00 | | 0.00 |
| Ammonia (28%), | | | | | |
| Actual Totals | 275.00 | 275.00 | 275.00 | 275.00 | 275.42 |

All aqueous coating compositions in the examples were prepared in the following manner:

Grind Procedure: Charged water, Tamol 731A, Byk019, CT111, and RM-5000 to grind pot. Using bench top dispersator, stirred for 2 min @ 5000 rpm. Added TiO2 gradually over 5 min. Increased agitation during this addition to maintain vortex (ended at 1800 rpm). Stirred for 5 minutes. Stopped stirring. Lowered grind pot and dislodged dry, coagulated, adhered TiO2 from stirring shaft and blades and dropped into grind pot. Restarted stirring. Maintained 1800 rpm for 25 min. After 25 minutes, removed sample for Hegman assessment. Some cooling was necessary for this batch of grind.

Results: On final Hegman analysis, no grit observed.

Paint Procedure:

Charged Let Down raw materials in order to paint container equipped with overhead stirrer. Then added the target weight of grind over ˜5 minutes adjusting stirring to maintain vortex. After all grind was added, stirred for aditional 2-5 minutes. Added remaining ingredients. Measured pH and adjusted to 8.2-9.2 as necessary with ammonia.

TABLE 1.2

| | Aqueous coating composition of Example | | | | |
|---|---|---|---|---|---|
| | Comp. | | | | |
| | Ex. A | 1 | 2 | 3 | 4 |
| Emulsion polymer | c | c | c | c | c |
| Equilibrated pH | 8.7 | 8.6 | 8.6 | 8.6 | 8.7 |
| Equil. Brookfield | 8900 | 6530 | 8790 | 7230 | 5410 |
| (sp3, 12 rpm) | | | | | |
| Equil. ICI | 1.6 | 1.8 | 2.5 | 1.9 | 2.6 |
| Equil. KU | 122 | 129 | 127 | 130 | 117 |
| Reflow/Repaint | | | | | |
| Test: | | | | | |
| Add on, g. | 9.8 | 11.8 | 9.8 | 11.1 | 10.5 |
| initial rating | 6 | 6, | 7 | 6 | 8 |
| 3 min | 5 | 7 | 7 | 7, | 9 |
| 5 min | 5 | 7 | 8 | 7, | 8 |
| 10 min | 3 | 5 | 3 | 4 | 5 |
| 15 min | 3 | 2 | 1 | 3 | 4 |
| X mark not seen | <3 | <3 (almost | 3 | 5 | 5 |
| at (min) | | imperceptible) | | | |
| DD Glass Gloss | | | | | |
| (20 deg): | | | | | |
| 1 day | 48 | 54 | 51 | 56 | 56 |
| 7 day | 44 | 49 | 45 | 51 | 54 |
| Konig Hardness | | | | | |
| DD, 3 mil sec | | | | | |
| 1 day | 47 | 53 | 19 | 56 | 67 |
| 2 days | 64 | 67 | 21 | 58 | 71 |
| 7 days | 76 | 95 | 29 | 87 | 100 |
| 14 days | 84 | 99 | 37 | 100 | 115 |
| 30 days | 96 | 116 | 47 | 115 | 124 |
| 60 days | 107 | 119 | 51 | 123 | 135 |
| Peel Block | | | | | |
| Resistance | | | | | |
| 1 day dry, RT | 2/2 | 7, 7 | 7/7 | 6, 6 | 2/2 |
| 1 day dry, 50 C. | 0/0 | 0, 0 | 0/0 | 0, 0 | 0/0 |
| 7 day dry, RT | 8/8 | 8, 8 | 9/9 | 8, 8 | 9, 8 |
| 7 day dry, 50* C. | 1/1 | 1, 0 | 0/0 | 0, 0 | 9, 8 |

Examples 1-4 of the invention exhibit application properties, particularly reflow/repaint ratings, superior to those of Comparative Example A that includes no autoxidizable material.

### EXAMPLES 5-9

Evaluation of aqueous coating compositions and coatings including ethoxylated glyceryl linoleate autooxidizable material

TABLE 5.1
Evaluation of aqueous coating compositions and coatings

| Aqueous coating composition | Comp. Ex. B | Comp. Ex. C | Example 5 |
|---|---|---|---|
| Aqueous emulsion polymer | a | a | a |
| Ethoxylated glyceryl Linoleate | 0% | 5% | 10% |
| (% on total binder) | | | |
| Ethoxylation number | 0 | 20 | 20 |
| Equil. KU | 119 | 120 | 112 |
| Equil. Brookfield, 6 rpm/sp 3 | 10120 | 6440 | 3580 |
| Equil. ICI | 2 | 2.1 | 2.65 |
| Reflow/repaint test (10 = best), | | | |
| brushed vertical | | | |
| Add on, g | 10.6 | 13.6 | 12.1 |
| initial rating | 4 | 7 | 9 |
| rating 3 min | 5 | 9 | 10 |
| rating 5 min | 5 | 9 | 10 |
| rating 7 min | 5 | 8 | 10 |
| rating 10 min | 4 | 7 | 10 |
| X mark passes at (min) | sl seen at 3′ | sl seen at 3′ | 10′ |
| 20°/60° brushed gloss 1 day | 39/75 | 66/90 | 72/88 |
| draw down 20°/60° Gloss | | | |
| (glass, 100 microns) | | | |
| 1 day | 69/88 | 78/91 | 76/88 |
| 7 day | 72/89 | 77/91 | 69/83 |
| Konig hardness (glass, | | | |
| 100 microns), sec | | | |
| 1 day | 31 | 30 | 18 |
| 7 day | 49 | 52 | 34 |
| 13 day | 59 | 62 | 42 |
| 30 day | 73 | 72 | 51 |
| RT Block Resistance E (N/cm2) | | | |
| 1 day dry | >10 | >10 | >10 |
| 7 day dry | 10 | 6.3 | 6.7 |

Example 5 of the invention exhibits application properties, particularly repaint ratings, superior to those of Comparative Examples B and C that include 0% and 5% autoxidizable material.

TABLE 5.2
Evaluation of aqueous coating compositions and coatings

| Aqueous coating | | | | |
|---|---|---|---|---|
| composition | Example 6 | Example 7 | Example 8 | Example 9 |
| Aqueous emulsion | f | f | f | f |
| polymer | | | | |
| Ethoxylated glyceryl | 10 | 15 | 10 | 15 |
| Linoleate (% on total | | | | |
| binder) | | | | |
| Ethoxylation number | 20 | 20 | 15 | 15 |
| Equil. KU | 102 | 102 | 102 | 104 |
| Equil. Brookfield, 6 rpm/ | 2780 | 2500 | 2820 | 2680 |
| sp 3 | | | | |
| Equil. ICI | 3 | 2.9 | 3 | 3 |
| Draw down 20°/ | | | | |
| 60° Gloss(glass, 100 | | | | |
| microns) | | | | |
| 1 day | 72/86 | 75/85 | 75/87 | 74/85 |
| 7 day | 70/83 | 72/88 | 73/85 | 73/82 |
| Konig hardness (glass, | | | | |
| 100 microns), sec | | | | |
| 1 day | 19 | 11 | 16 | 10 |
| 7 days | 34 | 22 | 26 | 20 |
| RT Block Resistance | | | | |
| 2 (N/cm2) | | | | |
| 1 day dry | >10 | >10 | >10 | >10 |
| 7 day dry | 10 | >10 | 9.4 | >10 |
| Large substrate reflow | | | | |
| test ratings (10 = | | | | |
| best), brushed vertical | | | | |
| add on, g | 45 | 46.3 | 39.4 | 41 |
| initial rating | 8 | 9 | 8 | 8 |
| rework rating 4 min | 7 | 8 | 6 | limit of |
| to half of the surface | | | | drying 7 |

Examples 6-9 including 10-15% autoxidizable material exhibit a desirable level of application properties.

### EXAMPLES 10-15

Evaluation of aqueous coating compositions and coatings including alkyd emulsion autoxidizable material

TABLE 10.1

| | Example | | |
|---|---|---|---|
| | Comp. Ex. D | Comp. Ex. E | 10 |
| Emulsion polymer | j | j | j |
| % Alkyd | | 5 RGE45/188 | 10 RGE45/188 |
| Equil. Brookfield | 8460 | 8560 | 6980 |
| viscosity (sp3, 12 rpm) | | | |
| Equil. ICI | 2.1 | 2.3 | 2.4 |
| Equil. KU | 122 | 131 | 124 |
| Reflow/repaint test: | | | |
| (10 = best) | | | |
| Add on, g. | 12.4 | 14.0 | 13.9 |
| initial rating | 5 | 7 | 7 |
| 3 min | 3 | 7 | 9+ |
| 5 min | 3 | 7 | 9, |
| 7 min | 3 | 6 | 7 |
| 10 min | 1 | 4 | 6 |
| X mark not seen at | 3 | <3 | <3 (barely |
| (min) | | | visible) |
| DD Glass Gloss (20 | | | |
| deg): | | | |
| 1 day | 60 | 65 | 69 |
| 7 day | 69 | 69 | 72 |
| Konig Hardness DD, | 7 mil | 7 mil | 7 mil |
| sec | | | |
| 1 day | 24 | 27 | 21 |
| 2 days | 27 | 29 | 23 |
| 7 days | 30 | 35 | 29 |
| 14 days | 33 | 36 | 34 |
| 1 mo. | 40 | 46 | 43 |
| 2 mo. | 48 | 55 | 60 |
| Peel Block | | | |
| Resistance | | | |
| 1 day dry, RT | 9/10 | 9/9 | 9/9 |
| 1 day dry, 50 C. | 9/9 | 7/8 | 7/5 |
| 7 day dry, RT | 9/9 | 9/9 | 9/8 |
| 7 day dry, 50 C. | 9/9 | 8/8 | 8/9 |

Example 10 of the invention exhibits application properties, particularly reflow/repaint ratings, superior to those of Comparative Examples D and E that include 0% and 5% autoxidizable material.

TABLE 10.2

| | Example | | | | |
|---|---|---|---|---|---|
| | Comp. Ex. F | 11 | 12 | 13 | 14 |
| Emulsion polymer | h | h | b | b | b |
| % Autooxidizable | | 20 WorleeSol | 30 WorleeSol | 20RGE45-80 | 30RGE 45- |
| material | | | | | 80 |
| Equil. Brookfield | 8460 | 7750 | 8380 | 4790 | 4130 |
| (sp3, 12 rpm) | | | | | |
| Equil. ICI | 2.1 | 2.1 | 2.1 | 2.5 | 2.3 |
| Equil. 0KU | 122 | 120 | 121 | 111 | 90 |
| Reflow/repaint test | | | | | |
| (10 = best) | | | | | |
| Add on, g. | 12.4 | 15.2 | 12.2 | 12.1 | 10.1 |
| initial rating, | 5 | 6 | 6 | 8 | 7 |
| 3 min | 3 | 7 | 6 | 8 | 8+ |
| 5 min | 3 | 6 | 6 | 9 | 7 |
| 7 min | 3 | 6 | 6 | 8 | 6 |
| 10 min | 1 | 4 | 5 | 7 | 6 |
| X mark not seen at | 3 | <3 (v.v. sl.) | <3 | 3 | 5 |
| (min) | | | | | |
| DD Glass Gloss (20 | | | | | |
| deg): | | | | | |
| 1 day | 60 | 46 | 68 | 79 | 80 |
| 7 day | 69 | 56 | 64 | 76 | 74 |
| Konig Hardness DD, | 3 mil | | 3 mil | 3 mil | 3 mil |
| sec | | | | | |
| 1 day | 34 | | 28 | 21 | 15 |
| 2 days | 36 | | 39 | 19 | 18 |
| 7 days | 45 | | 69 | 36 | 50 |
| 14 days | 49 | | 76 | 74 | 66 |
| 1 mo. | 64 | | 90 | 85 | 76 |
| 2 mo. | 73 | | 109 | 98 | 85 |
| Peel Block | | | | | |
| Resistance | | | | | |
| 1 day dry, RT | 9/10 | 1/1 | 2/2 | 2/2 | 2/2 |
| 1 day dry, 50 C. | 9/9 | 1/0 | 0/0 | 1/0 | 1/2 |
| 7 day dry, RT | 9/9 | 6/6 | 8/8 | 8/8 | 8/8 |
| 7 day dry, 50* C. | 9/9 | 0/0 | 0/0 | 8/8 | 6/6 |

Examples 11-14 of the invention demonstrate the use of 20-30% of alkyd emulsion autoxidizable material and exhibit application properties, particularly reflow/repaint ratings, superior to those of Comparative Example F that includes no autoxidizable material

### EXAMPLES 15-16

Evaluation of aqueous coating compositions and coatings including styrene/acrylic emulsion polymer and waterbased acrylate modified alkyd resin emulsion autoxidizable material.

Aqueous coating compositions were prepared at 35% VS, with 18% PVC R-906 TiO2 using 1% by weight, based on TiO2 weight, Orotan™ 731A.

TABLE 15.1

| | Example | | |
|---|---|---|---|
| | Comp. Ex. G | 15 | 16 |
| Binder ID | d | d | d |
| Surfactant (% | 3% | 0 | 0 |
| active/total binder | Glucopon ™ | | |
| solids) | 425 | | |
| Autoxidizable | 0 | 10% | 10% Cytec |
| material | | Cytec | RGE45-192 |
| | | RGE45- | |
| | | 188 | |
| Equil. KU (init/equil) | 108 | 100 | 101 |
| Equil. Brookfield, 6 rpm/ | 5820 | 4500 | 4860 |
| sp 3 (init/equil) | | | |
| Equil. ICI (init/equil) | 2.2 | 1.7 | 1.8 |
| Reflow/repaint ratings | | | |
| (10 = best), | | | |
| brushed vertical | | | |
| Add on, g | 11.5 | 10.6 | 12.6 |
| initial rating | 5 | 8 | 7 |
| rating 3 min | 5 | 8 | 8 |
| rating 5 min | 5 | 8 | 8 |
| rating 7 min | 4 | 7 | 7 |
| rating 10 min | 4 | 6 | 6 |
| X mark passes at | sl seen | sl seen 3′ | sl seen 3′ |
| (min) | 3′ | | |
| draw down 20°/60° Gloss | | | |
| (glass, 100 microns) | | | |
| 1 day | 78/94 | 54/85 | 55/85 |
| 8 day | 76/93 | 53/84 | 53/84 |
| Konig hardness (glass, 100 | | | |
| microns), sec | | | |
| 1 day | 23 | 23 | 23 |
| 8 day | 36 | 43 | 42 |
| 14 day | 43 | 57 | 55 |
| RT Block | | | |
| Resistance 2 | | | |
| (N/cm2) | | | |
| 1 day dry | >10 | >10 | >10 |
| 7 day dry | 2.6 | 9.4 | 8.2 |

Examples 15-16 of the invention exhibit application properties, particularly repaint ratings, superior to those of Comparative Example G that includes no autoxidizable material.

### EXAMPLES 17-18

Evaluation of aqueous coating compositions and coatings including glyceryl linoleate autoxidizable material.

TABLE 17.1

| | Example | | | |
|---|---|---|---|---|
| | Comp. | | Comp. | |
| | Ex. H | 17 | Ex. I | 18 |
| Emulsion | h | h | i | i |
| Polymer | | | | |
| Autoxidizable | 0 | 10% | 0 | 10% |
| material | | Glyceryl | | Glyceryl |
| | | Linoleate | | Linoleate |
| | | (emulsified) | | (emulsified) |
| Equil. KU | 133 | NA | 115 | 108 |
| Equil. Brookfield, | 15980 | 24900 (sp4) | 5320 | 5540 |
| 6 rpm/sp 3 | | | | |
| Equil. ICI | 2.5 | 3.2 | 2.6 | 2.0 |
| PH (initial) | 9.0 | 8.9 | 8.4 | 8.2 |
| Reflow/repaint | | | | |
| ratings (10 = best), | | | | |
| brushed vertical | | | | |
| add on, g. | 14.2 | 14.0 | 12.4 | 10.5 |
| initial rating | 6 | 8 | 8 | 9 |
| rating 3 min | 6 | 8 | 8 | 10 |
| rating 5 min | 6 | 8 | 8 | 10 |
| rating 10 min | 6 | 7 | 9 | 9 |
| rating 15 min | 5 | 7 | 7 | 8 |
| X mark passes at | 0′, 3′ | 0′-3′ | 5′-10′ | 5′ |
| (min) | | | | |
| 20°/60° brushed | 46.6/78.6 | 46.0/82.3 | 42.7/74.5 | 53.0/84.7 |
| gloss 1 day | | | | |

Glyceryl linoleate from Novance

Examples 17-18 of the invention exhibit application properties, particularly repaint ratings, superior to those of Comparative Examples H and I that include no autoxidizable material

### EXAMPLE 19

Evaluation of yellowing effect of diamine in coatings

Aqueous coating compositions including emulsion polymer a and Cytec autoxidizable material RGE 45/188 were prepared with various levels of diamine (Jeffamine™ED600). The aqueous coating compositions were aged for three months; then one 20 mil wet drawdown was made on a Leneta Opacity Chart, dried for 7 days followed by a second 20 mil drawdown and dried for an additional 7 days. Color Measurement was carried out using a Minolta CM-500i/CM-500c series. The illumination was D65 and the angle of observation was 10°. Measurement was reported from the black portion of the chart.

TABLE 19.1

| | Ratio (solid/solid) | Equivalents | | |
|---|---|---|---|---|
| | emulsion | Diamine on | | |
| Example | polymer/RGE45/188 | AAEM | b* | Y |
| 19 | 90/10 | 0 | 2.70 | 96.53 |
| Comp. Ex. J | 90/10 | 0.3 | 2.84 | 96.50 |
| Comp. Ex. K | 90/10 | 0.6 | 2.95 | 96.45 |
| Comp. Ex. L | 85/15 | 0.6 | 3.24 | 96.33 |
| Comp. Ex. M | 90/10 | 1.0 | 3.04 | 96.46 |

Example 19 coating of the invention exhibits less yellowing (lower b* value) than those Comparative Examples J-M that contain diamine.

### EXAMPLE 20

Evaluation of yellowing effect of diamine in coatings

Aqueous coating compositions including emulsion polymer a and Cytec autoxidizable material RGE 45/188 were prepared with various levels of diamine (Jeffamine™ED600). The aqueous coating compositions were heat aged for 10 days at 50° C.; then one 40 mil wet drawdown was made on a Leneta Opacity Chart, dried for 7 days followed by a second 10 mil drawdown and dried for an additional 7 days.

TABLE 20.1

| | Ratio (solid/solid) | Equivalents | | |
|---|---|---|---|---|
| | emulsion | Diamine on | | |
| Example | polymer/RGE45/188 | AAEM | b* | Y |
| 20 | 90/10 | 0 | 3.78 | 95.84 |
| Comp. Ex. N | 90/10 | 0.3 | 3.94 | 95.86 |
| Comp. Ex. O | 90/10 | 0.6 | 4.16 | 95.74 |
| Comp. Ex. P | 85/15 | 0.6 | 4.18 | 95.49 |
| Comp. Ex. Q | 90/10 | 1.0 | 4.45 | 95.60 |

Example 20 coating of the invention exhibits ;ess yellowing (lower b* value) than those of Comparative Examples N-Q that contain diamine.

### EXAMPLE 21

Evaluation of yellowing effect of diamine in coatings

Aqueous coating compositions including emulsion polymer e (two compositionally identical but different batches) and Cytec autoxidizable material RGE 45/188 were prepared with and without diamine (Jeffamine™ED600) and held at RT for 4.5 months. Then three 1 micron wet drawdowns was made one over the other on a Leneta Opacity Chart, dried for 7 days after each layer. The b* values were measured on the black portion of the chart using a Minolta CM-500i/CM-500c series spectrometer; the illumination was D65 and the angle of observation was 10°.

TABLE 21.1

| | Ratio (solid/solid) | Equivalents | |
|---|---|---|---|
| | emulsion | Diamine on | |
| Example | polymer/RGE45/188 | AAEM | b* |
| 21 | 90/10 | 0 | 1.5 |
| Comp. Ex. R | 90/10 | 0.2 | 2.05 |

Example 21 coating of the invention exhibited less yellowing (lower b* value) than that of Comparative Example R that contained diamine.

What is claimed is:

1. An aqueous polymeric composition comprising
an emulsion polymer comprising, as copolymerized units, from 0.5% to 25%, by weight based on the weight of said polymer, carbonyl-functional ethylenically-unsaturated monomer, and
an autoxidizable material having less than 10%, by weight based on the weight of fatty acid residues therein, tri-unsaturated fatty acid residues;
wherein said autoxidizable material is from 8% to 35% of the total weight of said polymer and said autoxidizable material; and
wherein said polymeric composition is free from copolymerized carbonyl-functional-monomer-reactive amine and hydrazine functional groups.

2. The aqueous polymeric composition of claim 1 wherein wherein said autoxidizable material is from 10% to 25% of the total weight of said polymer and said autoxidizable material.

3. An aqueous coating composition comprising a pigment and the aqueous polymeric composition of claim 1 or claim 2 wherein said coating composition is free from copolymerized carbonyl-functional-monomer-reactive amine and hydrazine functional groups.

4. A method for improving the repaintability of an aqueous coating during drying comprising:
(a) forming the aqueous coating composition of claim 3;
(b) applying said aqueous coating composition to a substrate; and
(c) applying additional said aqueous coating composition to said applied aqueous coating composition during drying.

5. A method for providing a coating comprising
(a) forming the aqueous coating composition of claim 3;
(b) applying said aqueous coating composition to a substrate; and
(c) drying, or allowing to dry, said applied aqueous coating composition.
